(19) United States
(12) Patent Application Publication
(10) Pub. No.: US 2025/0289343 A1
(43) Pub. Date: Sep. 18, 2025

(54) INFORMATION PROCESSING SYSTEM, MOVING OBJECT DEVICE, AND POWER SUPPLY DEVICE

(71) Applicant: HONDA MOTOR CO., LTD., Tokyo (JP)

(72) Inventor: Seiichiro KONDO, Tokyo (JP)

(73) Assignee: HONDA MOTOR CO., LTD., Tokyo (JP)

(21) Appl. No.: 19/060,801

(22) Filed: Feb. 24, 2025

(30) Foreign Application Priority Data
Mar. 18, 2024 (JP) 2024-041913

(51) Int. Cl. B60L 53/67; B60L 53/122; B60L 53/39; B60L 53/55; B60L 53/62; B60L 53/64; B60L 53/66

(52) U.S. Cl. CPC B60L 53/67; B60L 53/122; B60L 53/39; B60L 53/55; B60L 53/62; B60L 53/64; B60L 53/66

(57) ABSTRACT

An information processing system includes a processing device and power transmission systems. Each power transmission system includes a power supply device provided where a moving object having a secondary battery can be stopped, and a moving object device mounted on the moving object and performing contactless power transmission with the power supply device. The processing device communicates with one device of those devices. The one device acquires a positional deviation between the power supply device and the moving object device, acquires a voltage of the secondary battery, acquires transmittable power based on the acquired positional deviation and voltage from a storage storing information associating the positional deviation, the voltage of the secondary battery, and transmittable power under a condition thereof, and outputs information indicating the transmittable power to the processing device. The processing device derives total power from respective transmittable powers, and performs processing based on the total power.

### CROSS-REFERENCE TO RELATED APPLICATIONS

This application is based on and claims priority under 35 USC 119 from Japanese Patent Application No. 2024-041913 filed on Mar. 18, 2024, the entire content of which is incorporated herein by reference.

### TECHNICAL FIELD

The technique of the present disclosure relates to an information processing system, a moving object device, and a power supply device.

### BACKGROUND ART

In recent years, researches and developments have been conducted on charging and power feeding in a vehicle mounted with a secondary battery that contributes to an increase in energy efficiency in order to allow more users to access affordable, reliable, sustainable, and advanced energy.

For example, as researches and developments related to charging and power feeding, researches and developments related to contactless power transmission in which power is contactlessly transmitted between two devices have been conducted.

JP2018-148704A describes a technique for estimating a positional relationship between an appropriate position of a coil used for power transmission and a current position in a power transmission system.

JP2016-220464A describes a management system for a power transmitting device capable of contactlessly transmitting power to a power receiving device of a moving object.

WO2017/203579A describes a technique for detecting a position of a power receiving coil in a contactless power feeding system that feeds power from a ground-side power transmitting coil to a vehicle-side power receiving coil.

JP2018-198493A describes a contactless power transmission system capable of accurately aligning a primary coil and a secondary coil.

### SUMMARY OF INVENTION

An object of the technique of the present disclosure is to optimize a supply-demand balance of a power system to enable efficient use of power.

A first aspect of the present disclosure relates to an information processing system including an information processing device allowed to communicate with a plurality of contactless power transmission systems,
in which each of the contactless power transmission systems includes:
   a power supply device provided at a place where a moving object having a secondary battery is allowed to be stopped; and
   a moving object device mounted on the moving object and configured to be allowed to perform contactless power transmission with the power supply device,
the secondary battery is allowed to be charged or discharged by performing the contactless power transmission between the power supply device and the moving object device,
the information processing device is provided to be allowed to communicate with at least one device of the moving object device or the power supply device included in the contactless power transmission system,
the one device is configured to:
   acquire a positional deviation amount between a power supply-side coil of the power supply device of the contactless power transmission system including the one device, and a moving object-side coil of the moving object device of the contactless power transmission system including the one device;
   acquire a voltage of the secondary battery of the moving object on which the moving object device of the contactless power transmission system including the one device is mounted;
   acquire transmittable power in a case where the contactless power transmission system including the one device performs the contactless power transmission, based on the acquired positional deviation amount and the acquired voltage, from a storage unit that stores information associating the positional deviation amount between the power supply-side coil and the moving object-side coil, the voltage of the secondary battery, and transmittable power in a case where the contactless power transmission is performed between the power supply device and the moving object device under a condition of the positional deviation amount and the voltage; and
   output information indicating the transmittable power to the information processing device, and
the information processing device derives, based on the information indicating the transmittable power output from the one device of each of the plurality of contactless power transmission systems, total power obtained by adding up respective transmittable powers, and performs processing based on the total power.

A second aspect of the present disclosure relates to an information processing system including an information processing device allowed to communicate with a plurality of contactless power transmission systems,
in which each of the contactless power transmission systems includes:
   a power supply device provided at a place where a moving object having a secondary battery is allowed to be stopped; and
   a moving object device mounted on the moving object and configured to be allowed to perform contactless power transmission with the power supply device,
the secondary battery is allowed to be charged or discharged by performing the contactless power transmission between the power supply device and the moving object device,
the information processing device is provided to be allowed to communicate with at least one device of the moving object device or the power supply device included in the contactless power transmission system,
the one device is configured to:
   acquire a coupling coefficient between a power supply-side coil of the power supply device of the contactless power transmission system including the one device, and a moving object-side coil of the moving object device of the contactless power transmission system including the one device;
   derive transmittable power in a case where the contactless power transmission system including the one device performs the contactless power transmission, based on the coupling coefficient; and
   output information indicating the transmittable power to the information processing device, and
the information processing device derives, based on the information indicating the transmittable power output from the one device of each of the plurality of contactless power transmission systems, total power obtained by adding up respective transmittable powers, and performs processing based on the total power.

A third aspect of the present disclosure relates to a moving object device mounted on a moving object having a secondary battery allowed to be charged or discharged by contactless power transmission, and configured to be allowed to perform the contactless power transmission with a power supply device provided at a place where the moving object is allowed to be stopped, the moving object device including:
a moving object-side coil; and
a control unit,
in which the control unit is configured to:
   acquire a positional deviation amount between a power supply-side coil of the power supply device and the moving object-side coil;
   acquire a voltage of the secondary battery;
   acquire transmittable power in a case where the contactless power transmission is performed with the power supply device, based on the acquired positional deviation amount and the acquired voltage, from a storage unit that stores information associating the positional deviation amount between the power supply-side coil and the moving object-side coil, the voltage of the secondary battery, and transmittable power in a case where the contactless power transmission is performed between the power supply device and the moving object device under a condition of the positional deviation amount and the voltage; and
   output information indicating the transmittable power to an outside.

A fourth aspect of the present disclosure relates to a moving object device mounted on a moving object having a secondary battery allowed to be charged or discharged by contactless power transmission, and configured to be allowed to perform the contactless power transmission with a power supply device provided at a place where the moving object is allowed to be stopped, the moving object device including:
a moving object-side coil; and
a control unit,
in which the control unit is configured to:
   acquire a coupling coefficient between a power supply-side coil of the power supply device and the moving object-side coil;
   derive transmittable power in a case where the contactless power transmission is performed with the power supply device, based on the coupling coefficient; and
   output information indicating the transmittable power to an outside.

A fifth aspect of the present disclosure relates to a power supply device configured to be allowed to perform contactless power transmission with a moving object device mounted on a moving object having a secondary battery allowed to be charged or discharged by the contactless power transmission, and provided at a place where the moving object is allowed to be stopped, the power supply device including:
a power supply-side coil; and
a control unit,
in which the control unit is configured to:
   acquire a positional deviation amount between the power supply-side coil and a moving object-side coil of the moving object device;
   acquire a voltage of the secondary battery;
   acquire transmittable power in a case where the contactless power transmission is performed with the moving object device, based on the acquired positional deviation amount and the acquired voltage, from a storage unit that stores information associating the positional deviation amount between the power supply-side coil and the moving object-side coil, the voltage of the secondary battery, and transmittable power in a case where the contactless power transmission is performed between the power supply device and the moving object device under a condition of the positional deviation amount and the voltage; and
   output information indicating the transmittable power to an outside.

A sixth aspect of the present disclosure relates to a power supply device configured to be allowed to perform contactless power transmission with a moving object device mounted on a moving object having a secondary battery allowed to be charged or discharged by the contactless power transmission, and provided at a place where the moving object is allowed to be stopped, the power supply device including:
a power supply-side coil; and
a control unit,
in which the control unit is configured to:
   acquire a coupling coefficient between the power supply-side coil and a moving object-side coil of the moving object device;
   derive transmittable power in a case where the contactless power transmission is performed with the moving object device, based on the coupling coefficient; and
   output information indicating the transmittable power to an outside.

According to the aspects of the present disclosure, it is possible to optimize the supply-demand balance of the power system to enable effective use of power.

### BRIEF DESCRIPTION OF DRAWINGS

Exemplary embodiment(s) of the present invention will be described in detail based on the following figures, wherein:

FIG. 1 is a schematic diagram illustrating an information processing system 200 according to an embodiment of the technique of the present disclosure;

FIG. 2 is a schematic diagram illustrating a specific configuration example of the contactless power transmission system 100 illustrated in FIG. 1;

FIG. 3 is a schematic diagram illustrating an operation state of the contactless power transmission system 100 during execution of power feeding control by a moving object device 10;

FIG. 4 is a schematic diagram illustrating a configuration of the contactless power transmission system 100 in a charging mode of the information processing system 200;

FIG. 5 is a schematic diagram illustrating a first example of an operation of the contactless power transmission system 100 when an information processing device 50 performs bidding processing on a supply-demand adjustment server 70;

FIG. 6 is a schematic diagram illustrating a second example of the operation of the contactless power transmission system 100 when the information processing device 50 performs the bidding processing on the supply-demand adjustment server 70;

FIG. 7 is a schematic diagram illustrating a third example of the operation of the contactless power transmission system 100 when the information processing device 50 performs the bidding processing on the supply-demand adjustment server 70;

FIG. 8 is a schematic diagram illustrating a fourth example of the operation of the contactless power transmission system 100 when the information processing device 50 performs the bidding processing on the supply-demand adjustment server 70;

FIG. 9 is a schematic diagram illustrating a first example of the operation of the contactless power transmission system 100 when the information processing device 50 performs power order processing on the supply-demand adjustment server 70; and

FIG. 10 is a schematic diagram illustrating a second example of the operation of the contactless power transmission system 100 when the information processing device 50 performs the power order processing on the supply-demand adjustment server 70.

### DESCRIPTION OF EMBODIMENTS

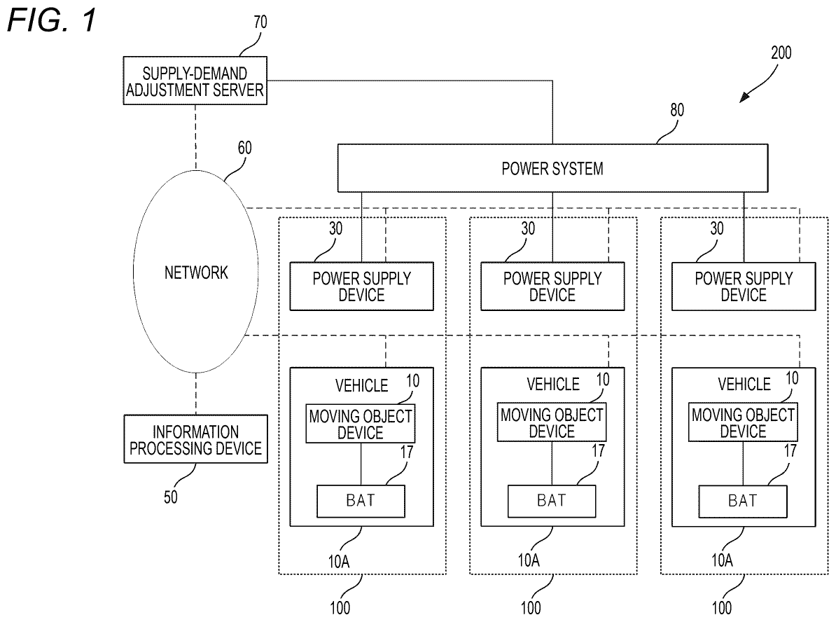

FIG. 1 is a schematic diagram illustrating the information processing system 200 according to an embodiment of the technique of the present disclosure. The information processing system 200 includes a plurality of contactless power transmission systems 100, an information processing device 50 capable of communicating with the plurality of contactless power transmission systems, a power system 80 connected to the contactless power transmission systems 100, and a supply-demand adjustment server 70 that performs processing such as adjustment of power amount supplied from the power system 80 to the contactless power transmission systems 100 and adjustment of power amount supplied from the contactless power transmission systems 100 to the power system 80. The information processing device 50, the supply-demand adjustment server 70, and the contactless power transmission systems 100 are connected to a network 60 such as the Internet.

Each of the contactless power transmission systems 100 includes a power supply device 30 provided at a place where a moving object 10A having a secondary battery 17 (denoted as BAT in the figure) such as a lithium ion battery or a nickel hydrogen battery can be stopped, and a moving object device 10 mounted on the moving object 10A and configured to be capable of contactless power transmission with the power supply device 30. The moving object 10A includes, for example, a drive source that is driven using power of the secondary battery 17. The moving object 10A is, for example, a vehicle such as an automobile, a drone, a ship, or an aircraft. The place where the moving object 10A can be stopped is, for example, a parking lot, a facility, or a house.

The contactless power transmission system 100 is configured to be able to perform first power transmission from the moving object device 10 to the power supply device 30 and second power transmission from the power supply device 30 to the moving object device 10. The moving object device 10 and the power supply device 30 perform contactless power transmission using magnetic coupling between coils of, for example, a magnetic resonance method or an electromagnetic induction method.

The power supply device 30 is connected to the power system 80, and can charge the secondary battery 17 of the moving object 10A on which the moving object device 10 is mounted by transmitting power supplied from the power system 80 to the moving object device 10. The power supply device 30 can supply the power of the secondary battery 17 transmitted from the moving object device 10 to the power system 80.

In the contactless power transmission system 100, one (both of the power supply device 30 and the moving object device 10 in the example of FIG. 1) of the power supply device 30 and the moving object device 10 can be connected to the network 60, and is configured to communicate with the information processing device 50. The information processing device 50 manages the contactless power transmission system 100.

The information processing system 200 can adopt a feeding mode in which the power system 80 receives power supply from the contactless power transmission system 100, and a charging mode in which the contactless power transmission system 100 receives power required for charging the secondary battery 17 from the power system 80.

In the feeding mode, the information processing device 50 predicts a total power amount that can be supplied from all the contactless power transmission systems 100 to the power system 80 at a predetermined cycle (for example, one day), and performs bidding processing of power supply to the power system 80 based on the predicted value in a predetermined period (for example, one day) after the predicted value is derived. For example, the information processing device 50 performs the bidding processing of the power supply to the power system 80 on the next day, based on a predicted value derived at night of a certain day, on the supply-demand adjustment server 70. The supply-demand adjustment server 70 receives bidding processing from a number of merchants, and performs winning bid processing to determine which merchant supplies power. When a merchant who manages the information processing device 50 wins the bid, the power is supplied from the contactless power transmission system 100 to the power system 80 on the next day, and a compensation is paid to the merchant.

In a charging state, the information processing device 50 predicts total power amount consumed by all the contactless power transmission systems 100 at the predetermined cycle, and performs power order processing for transmitting the predicted value to the supply-demand adjustment server 70. The supply-demand adjustment server 70 adjusts power amount generated by the power system 80 based on the predicted value in the predetermined period after the predicted value is received.

As described above, in the information processing system 200, in order to stabilize the supply-demand of power in the power system 80, it is important to more accurately grasp how much power is supplied from all the contactless power transmission systems 100 connected to the power system 80, or how much power is required to be supplied to all the contactless power transmission systems 100 connected to the power system 80.

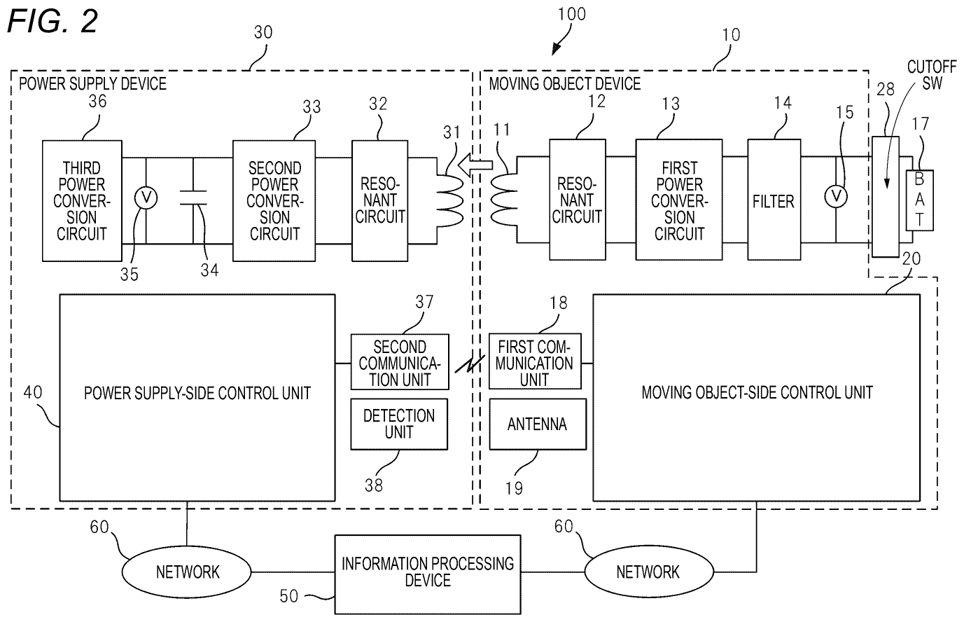

FIG. 2 is a schematic diagram illustrating a specific configuration example of the contactless power transmission system 100 illustrated in FIG. 1. As illustrated in FIG. 2, the moving object device 10 includes a moving object-side coil 11, a resonant circuit 12 connected to the moving object-side coil 11, a first power conversion circuit 13 connected to the resonant circuit 12, a filter 14 provided between the first power conversion circuit 13 and the secondary battery 17, a voltage detection circuit 15 provided between the filter 14 and the secondary battery 17, a cutoff switch 28 provided between the voltage detection circuit 15 and the secondary battery 17, a first communication unit 18, an antenna 19, and a moving object-side control unit 20.

The resonant circuit 12 includes, for example, a capacitor connected in series to the moving object-side coil 11. During the first power transmission, the moving object-side coil 11 and the resonant circuit 12 constitute a power transmitting unit that transmits power to the power supply device 30 by contactless power transmission.

The antenna 19 is provided to detect a position of the moving object-side coil 11 in the power supply device 30.

During the first power transmission, the first power conversion circuit 13 generates supply power to be supplied to the moving object-side coil 11 and the resonant circuit 12 using the power of the secondary battery 17, and supplies the supply power to the moving object-side coil 11 and the resonant circuit 12. The first power conversion circuit 13 includes a switching element such as a transistor, and operates, for example, as an inverter that converts a direct current supplied from the secondary battery 17 into a high-frequency alternating current during the first power transmission. The high-frequency alternating current converted by the first power conversion circuit 13 is input to the moving object-side coil 11, and a high-frequency alternating current is induced by an electromagnetic induction effect in a power supply-side coil 31 of the power supply device 30 facing the moving object-side coil 11 with a gap therebetween.

The filter 14 is provided to stabilize power and remove noise.

The cutoff switch 28 is configured to switch between a connection state in which the filter 14 and the secondary battery 17 are electrically connected and a cutoff state in which the connection is cut off.

The voltage detection circuit 15 detects a terminal voltage Vb of the secondary battery 17 in the feeding mode of the information processing system 200. In the charging mode of the information processing system 200, the voltage detection circuit 15 detects an output voltage which is output from the first power conversion circuit 13 and in which noise is removed by the filter 14.

The first communication unit 18 is an interface for performing near field wireless communication. For the near field wireless communication, for example, Wi-Fi (Registered trademark), Bluetooth (Registered trademark), or the like can be used.

The moving object-side control unit 20 includes a processor such as a central processing unit (CPU) and a memory, and performs various controls related to power transmission.

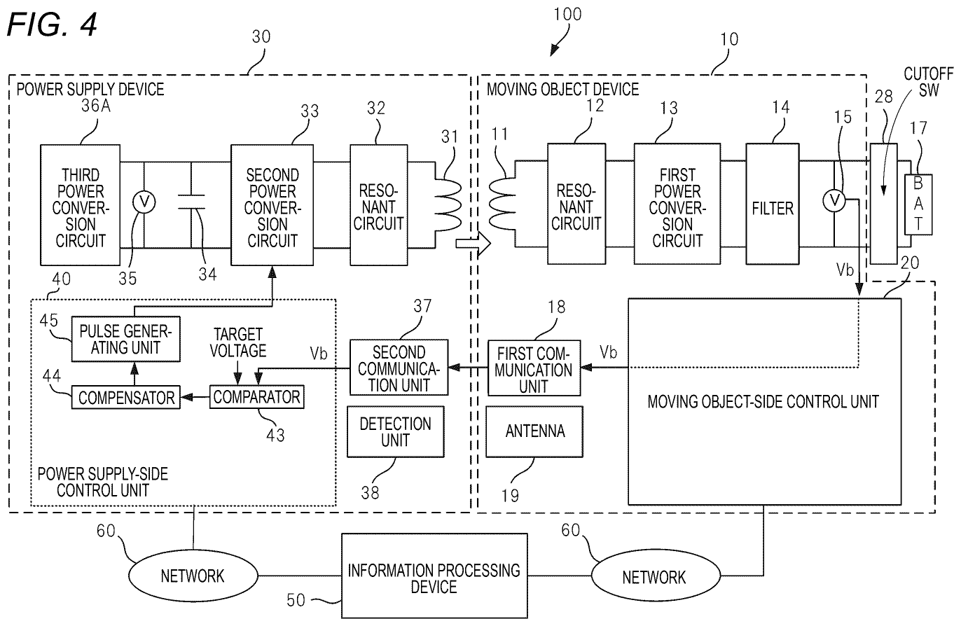

The power supply device 30 includes the power supply-side coil 31, a resonant circuit 32 connected to the power supply-side coil 31, a second power conversion circuit 33 connected to the resonant circuit 32, a capacitor 34 connected to the second power conversion circuit 33, a voltage detection circuit 35 configured to detect a terminal voltage Vc of the capacitor 34, a third power conversion circuit 36 connected to the capacitor 34, a second communication unit 37, a detection unit 38, and a power supply-side control unit 40. Although not shown in FIG. 2, a power factor correction circuit 36A (see FIG. 4) is provided in the power supply device 30. In the charging mode of the information processing system 200, the third power conversion circuit 36 in FIG. 2 is replaced with the power factor correction circuit 36A.

The resonant circuit 32 includes, for example, a capacitor connected in series to the power supply-side coil 31. In the feeding mode of the information processing system 200, the power supply-side coil 31 and the resonant circuit 32 constitute a power receiving unit that receives power transmitted from the moving object device 10 by the contactless power transmission.

In the feeding mode of the information processing system 200, the second power conversion circuit 33 operates as a rectifier, and converts a high-frequency alternating current input from the power supply-side coil 31 into a direct current.

The capacitor 34 is charged with the direct current converted by the second power conversion circuit 33. In the feeding mode of the information processing system 200, the capacitor 34 is configured to be able to supply the stored power to the power system 80 connected to the third power conversion circuit 36.

In the feeding mode of the information processing system 200, the third power conversion circuit 36 operates as an inverter, and converts a direct current discharged from the capacitor 34 into an alternating current having a frequency of a commercial power supply. The alternating current having a commercial frequency converted by the third power conversion circuit 36 is supplied to the power system 80.

The second communication unit 37 is an interface for performing near field wireless communication. For the near field wireless communication, for example, Wi-Fi (Registered trademark), Bluetooth (Registered trademark), or the like can be used.

The detection unit 38 detects positions of the moving object-side coil 11 in an X direction and a Y direction by detecting a radio wave from the antenna 19. The X direction and the Y direction are directions orthogonal to each other and orthogonal to a vertical direction.

In the contactless power transmission system 100, the moving object device 10 is mounted on the moving object 10A, and thus the position of the moving object-side coil 11 relative to the power supply-side coil 31 varies. Hereinafter, the position of the moving object-side coil 11 relative to the power supply-side coil 31 capable of achieving contactless power transmission with maximum efficiency will be referred to as a reference position. The reference position is defined by coordinates in the X direction, the Y direction, and a Z direction when a position of the power supply-side coil 31 is set as an origin.

When the moving object-side coil 11 is displaced from the reference position, the power that can be transmitted between the moving object device 10 and the power supply device 30 is less than the power when the moving object-side coil 11 is at the reference position due to a deviation amount. The deviation amount of the position of the moving object-side coil 11 from the reference position corresponds to a positional deviation amount between the power supply-side coil 31 and the moving object-side coil 11.

The power supply-side control unit 40 includes a processor such as a central processing unit (CPU) and a memory, and performs overall control on the power supply device 30.

The power supply-side control unit 40 derives a positional deviation amount MA of the position of the moving object-side coil 11 relative to the reference position based on information on a position Px in the X direction and a position Py in the Y direction of the moving object-side coil 11 detected by the detection unit 38 and information on a position Pz in the Z direction of the moving object-side coil 11 acquired from the moving object device 10 via the first communication unit 18 and the second communication unit 37. The positional deviation amount MA is one factor that determines power (hereinafter referred to as transmittable power) that can be transmitted between the moving object device 10 and the power supply device 30.

In the feeding mode of the information processing system 200, the moving object-side control unit 20 of the moving object device 10 acquires the terminal voltage Vc of the capacitor 34 of the power supply device 30, and executes power feeding control for controlling the supply power supplied to the moving object-side coil 11 and the resonant circuit 12 via the first power conversion circuit 13 such that the terminal voltage Vc becomes a predetermined target voltage.

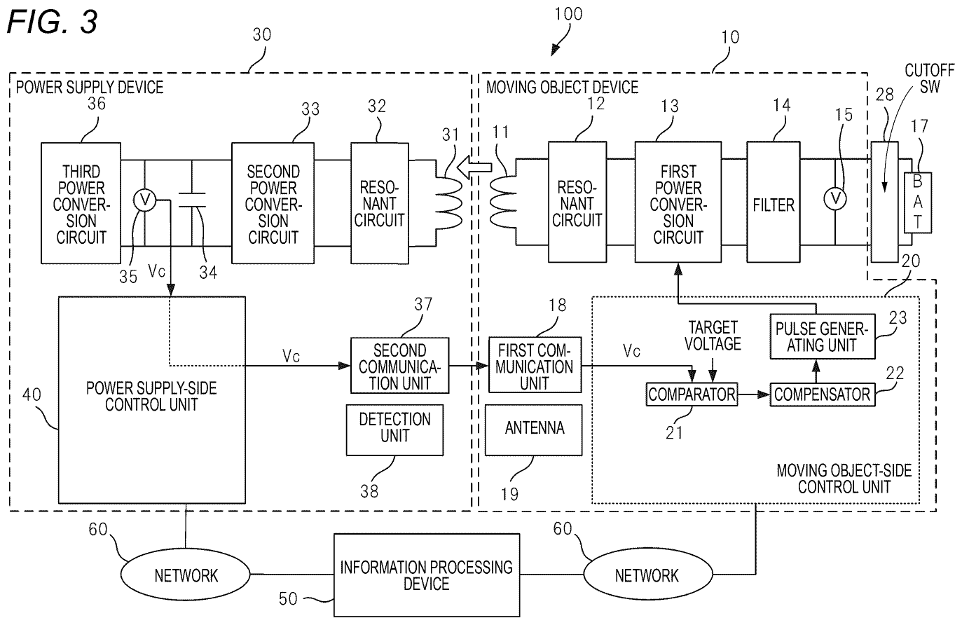

FIG. 3 is a schematic diagram illustrating an operation state of the contactless power transmission system 100 during execution of power feeding control by the moving object device 10. When the power feeding control is started, the power supply-side control unit 40 acquires the terminal voltage Vc from the voltage detection circuit 35 and performs control to transmit the acquired terminal voltage Vc from the second communication unit 37 to the moving object device 10. The terminal voltage Vc transmitted from the second communication unit 37 is received by the first communication unit 18 and acquired by the moving object-side control unit 20.

As illustrated in FIG. 3, the moving object-side control unit 20 includes a comparator 21, a compensator 22, and a pulse generating unit 23. These are configured by hardware, software, or a combination thereof. The comparator 21 compares the terminal voltage Vc acquired by the first communication unit 18 with the target voltage, and outputs a deviation therebetween.

Based on a deviation input from the comparator 21, the compensator 22 performs phase compensation for adjusting a phase characteristic of a system (a charging system including the resonant circuit 12 provided between the first power conversion circuit 13 and the capacitor 34, the moving object-side coil 11, the power supply-side coil 31, the resonant circuit 32, and the second power conversion circuit 33) for charging the capacitor 34 with the power transmitted from the moving object device 10, and determines input power to the system such that a phase margin between the input and the output of the system is 0 degrees or more.

The pulse generating unit 23 generates a drive pulse and supplies the drive pulse to the first power conversion circuit 13 such that the power output from the first power conversion circuit 13 becomes the input power determined by the compensator 22.

FIG. 4 is a schematic diagram illustrating a configuration of the contactless power transmission system 100 in the charging mode of the information processing system 200. In the charging mode, an alternating current is supplied from the power system 80 to the second power conversion circuit 33 via the power factor correction circuit 36A. The second power conversion circuit 33 converts the alternating current input from the power factor correction circuit 36A into a high-frequency alternating current. The power supply-side control unit 40 includes a comparator 43, a compensator 44, and a pulse generating unit 45 corresponding to the comparator 21, the compensator 22, and the pulse generating unit 23 in the moving object-side control unit 20, respectively.

In the charging mode, the power supply-side control unit 40 acquires the terminal voltage Vb of the secondary battery 17 from the moving object device 10, and executes power feeding control for controlling supply power supplied to the power supply-side coil 31 and the resonant circuit 32 via the second power conversion circuit 33 such that the terminal voltage Vb becomes a predetermined target voltage.

In this way, in the charging mode, the power supply-side control unit 40 uses a system for charging the secondary battery 17 with the power transmitted from the power supply device 30 to the moving object device 10 as a control target to control input power of the control target such that an output voltage (synonymous with the terminal voltage Vb) of the control target becomes a target voltage.

When the power feeding control by the power supply-side control unit 40 is started, the moving object-side control unit 20 acquires the terminal voltage Vb from the voltage detection circuit 15 and performs control to transmit the acquired terminal voltage Vb from the first communication unit 18 to the power supply device 30. The terminal voltage Vb transmitted from the first communication unit 18 is received by the second communication unit 37 and acquired by the power supply-side control unit 40.

The comparator 43 compares the terminal voltage Vb acquired by the second communication unit 37 with the target voltage, and outputs a deviation therebetween. The compensator 44 performs phase compensation for adjusting a phase characteristic of the control target based on the deviation input from the comparator 43, and determines the input power to the control target such that a phase margin between the input and the output of the control target is 0 degrees or more.

The pulse generating unit 45 generates a drive pulse and supplies the drive pulse to the second power conversion circuit 33 such that the power output from the second power conversion circuit 33 becomes the input power determined by the compensator 44.

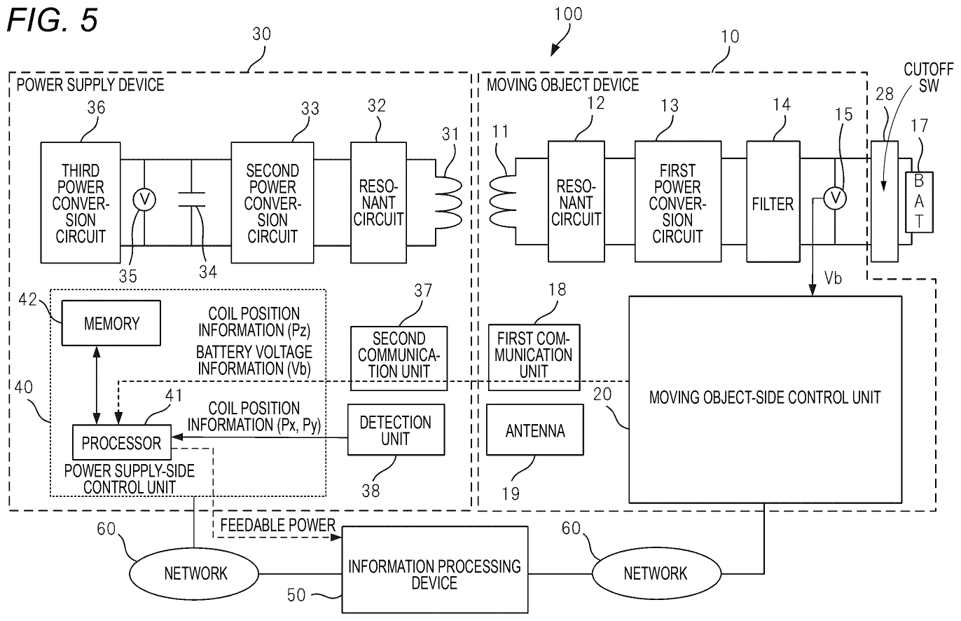

FIG. 5 is a schematic diagram illustrating a first example of an operation of the contactless power transmission system 100 when the information processing device 50 performs the bidding processing on the supply-demand adjustment server 70.

The power supply-side control unit 40 includes a processor 41 and a memory 42. In the memory 42, the positional deviation amount of the position of the moving object-side coil 11 relative to the reference position, the terminal voltage of the secondary battery 17, and maximum power (hereinafter, referred to as “feedable power”) that can be transmitted from the moving object device 10 to the power supply device 30 when the contactless power transmission is performed between the moving object device 10 and the power supply device 30 under a condition of the positional deviation amount and the terminal voltage are stored in association with each other. Information on a combination of the positional deviation amount and the terminal voltage and the feedable power corresponding to the combination is experimentally acquired and stored in the memory 42.

When a user of the moving object 10A performs alignment between the moving object 10A and the power supply device 30, the moving object-side control unit 20 acquires the terminal voltage Vb from the voltage detection circuit 15. The moving object-side control unit 20 transmits the information on the position Pz in the Z direction of the moving object-side coil 11 and information on the acquired terminal voltage Vb from the first communication unit 18 to the power supply device 30.

The processor 41 of the power supply-side control unit 40 acquires the information on the position Pz and the information on the terminal voltage Vb transmitted from the moving object device 10. The processor 41 acquires the information on the position Px in the X direction and the information on the position Py in the Y direction of the moving object-side coil 11 from the detection unit 38. The processor 41 derives the positional deviation amount MA of the position of the moving object-side coil 11 relative to the reference position from the acquired information on the positions.

Next, based on the derived positional deviation amount MA and the information on the terminal voltage Vb acquired from the moving object device 10, the processor 41 reads out and acquires the information on the feedable power corresponding to the combination from the memory 42.

The information on the combination of the positional deviation amount and the terminal voltage and the feedable power corresponding to the combination may be stored in a server or the like connected to the network 60 instead of the memory 42 in the power supply device 30. In this case, the processor 41 may acquire the information on the feedable power from the server.

When the processor 41 acquires the information on the feedable power, the processor 41 transmits the information to the information processing device 50. By performing the above operations in all the contactless power transmission systems 100, the information processing device 50 transmits the information on the feedable power for the number of the contactless power transmission systems 100.

The information processing device 50 derives total power obtained by adding up respective feedable powers based on the information on the feedable power received from each of the contactless power transmission systems 100. The information processing device 50 performs processing based on the total power.

For example, the information processing device 50 derives a predicted value of the power amount that can be supplied from all of the contactless power transmission systems 100 to the power system 80 based on the total power on the next day of the day when the total power is derived. Based on the predicted value, the information processing device 50 performs the bidding processing of the power supply to the power system 80 on the next day on the supply-demand adjustment server 70.

In the example of FIG. 5, the power supply device 30 derives the feedable power and transmits the information on the feedable power to the information processing device 50, but the moving object device 10 may derive the feedable power and transmit the information on the feedable power to the information processing device 50.

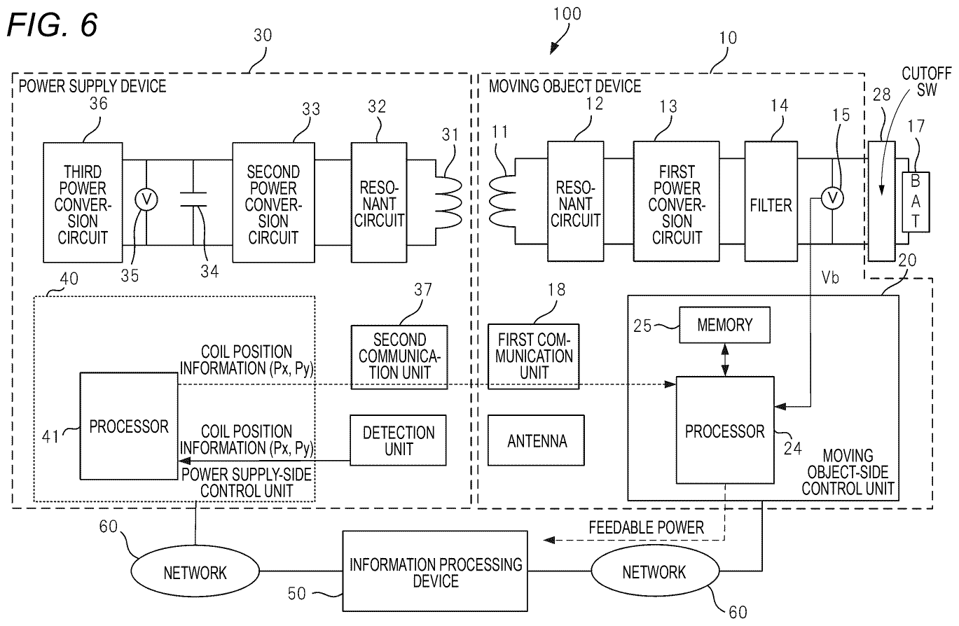

FIG. 6 is a schematic diagram illustrating a second example of the operation of the contactless power transmission system 100 when the information processing device 50 performs the bidding processing on the supply-demand adjustment server 70.

In the example of FIG. 6, the moving object-side control unit 20 includes a processor 24 and a memory 25. In the memory 25, the information (the information on the combination of the positional deviation amount and the terminal voltage and the feedable power corresponding to the combination) stored in the memory 42 in the example of FIG. 5 is stored.

When the user of the moving object 10A performs alignment between the moving object 10A and the power supply device 30, the processor 24 of the moving object-side control unit 20 acquires the terminal voltage Vb from the voltage detection circuit 15.

When the alignment is performed, the processor 41 of the power supply-side control unit 40 acquires the information on the position Px in the X direction and the information on the position Py in the Y direction of the moving object-side coil 11 from the detection unit 38, and transmits the acquired information to the moving object device 10 via the second communication unit 37.

The processor 24 of the moving object-side control unit 20 derives the positional deviation amount MA based on the information on the position Px and the position Py acquired from the power supply device 30 and the information on the position Pz of the moving object-side coil 11 stored in the memory 25. Based on the derived positional deviation amount MA and the acquired information on the terminal voltage Vb, the processor 24 reads out and acquires the information on the feedable power corresponding to the combination from the memory 25. When the processor 24 acquires the information on the feedable power, the processor 24 transmits the information to the information processing device 50.

In the above description, the operation of the contactless power transmission system 100 when the information processing device 50 performs the power order processing on the supply-demand adjustment server 70 is stored in the memory 42 or the memory 25 in association with the positional deviation amount of the position of the moving object-side coil 11 relative to the reference position, the terminal voltage of the secondary battery 17, and power (hereinafter, referred to as chargeable power) that can be transmitted from the power supply device 30 to the moving object device 10 when the contactless power transmission is performed between the moving object device 10 and the power supply device 30 under the condition of the positional deviation amount and the terminal voltage. The feedable power is replaced with the chargeable power.

As described above, according to the information processing system 200, it is possible to derive the transmittable power (the feedable power or the chargeable power) determined based on the positional relationship between the moving object-side coil 11 and the power supply-side coil 31 in each of the contactless power transmission systems 100, and perform the bidding processing or the power order processing to the power system 80 based on the information on the transmittable power.

For this reason, in a feeding state of the information processing system 200, it is possible to supply the power under a pre-bid condition to the power system 80. In addition, in the charging state of the information processing system 200, it is possible to consume the power under a condition notified in advance from the power system 80. As a result, the supply-demand balance of the power system 80 can be made appropriate, and the power can be effectively used.

In the above description, the power supply device 30 or the moving object device 10 acquires the feedable power or the chargeable power based on information experimentally obtained.

When a state of magnetic coupling between the moving object-side coil 11 and the power supply-side coil 31 is known, values of both the feedable power and the chargeable power can be derived. For example, in the contactless power transmission system 100, the moving object-side control unit 20 or the power supply-side control unit 40 may acquire the coupling coefficient indicating a strength of the magnetic coupling between the moving object-side coil 11 and the power supply-side coil 31, and derive the feedable power or the chargeable power based on the coupling coefficient. Such an operation will be described below.

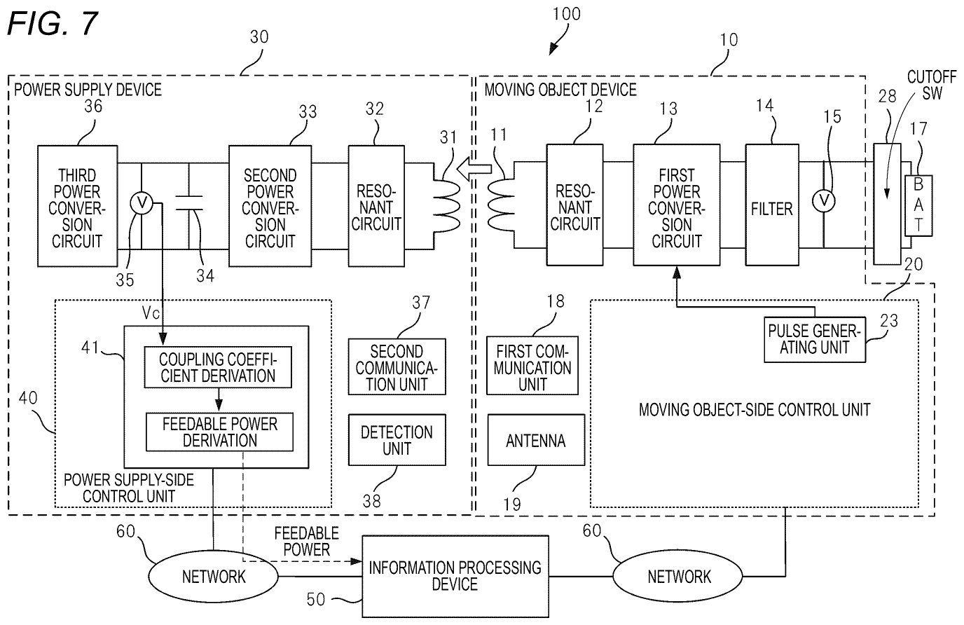

FIG. 7 is a schematic diagram illustrating a third example of the operation of the contactless power transmission system 100 when the information processing device 50 performs the bidding processing on the supply-demand adjustment server 70.

When the user of the moving object 10A performs alignment between the moving object 10A and the power supply device 30, the moving object-side control unit 20 controls the cutoff switch 28 to the connection state. In addition, the moving object-side control unit 20 generates a drive pulse with a predetermined pattern (a pattern with a fixed pulse width and fixed frequency) by the pulse generating unit 23, and controls the first power conversion circuit 13 in accordance with the drive pulse, thereby controlling the supply power to the moving object-side coil 11 and the resonant circuit 12 to predetermined power (a constant value). When the control is started, constant power is transmitted from the moving object device 10 to the power supply device 30, the capacitor 34 is charged with the power, and the terminal voltage Vc increases.

When the transmission of the constant power from the moving object device 10 is started, the processor 41 of the power supply-side control unit 40 acquires the terminal voltage Vc from the voltage detection circuit 35, and derives the coupling coefficient between the moving object-side coil 11 and the power supply-side coil 31 based on the terminal voltage Vc.

The processor 41 derives the feedable power based on the derived coupling coefficient, and transmits the information on the feedable power to the information processing device 50.

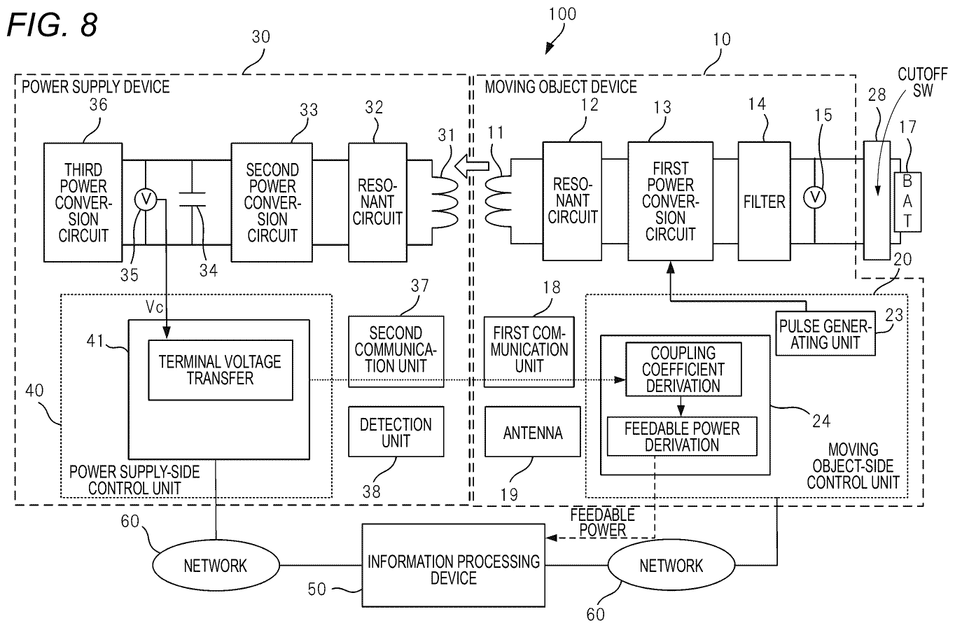

FIG. 8 is a schematic diagram illustrating a fourth example of the operation of the contactless power transmission system 100 when the information processing device 50 performs the bidding processing on the supply-demand adjustment server 70.

In the example of FIG. 7, the processor 41 acquires the coupling coefficient and derives the feedable power, but in the example of FIG. 8, the processor 24 of the moving object-side control unit 20 acquires the coupling coefficient and derives the feedable power.

In the example of FIG. 8, when the constant power is transmitted from the moving object device 10 to the power supply device 30 in the same manner as the example of FIG. 7, the processor 41 of the power supply-side control unit 40 acquires the terminal voltage Vc from the voltage detection circuit 35 and stores data on a time-series transition of the terminal voltage Vc in the memory. When the data on the terminal voltage Vc necessary for deriving the coupling coefficient is accumulated, the processor 41 transmits the data to the moving object device 10.

When the processor 24 of the moving object-side control unit 20 acquires the data on the terminal voltage Vc transmitted from the power supply device 30, the processor 24 derives the coupling coefficient between the moving object-side coil 11 and the power supply-side coil 31 based on the data. The processor 24 derives the feedable power based on the derived coupling coefficient, and transmits the information on the feedable power to the information processing device 50.

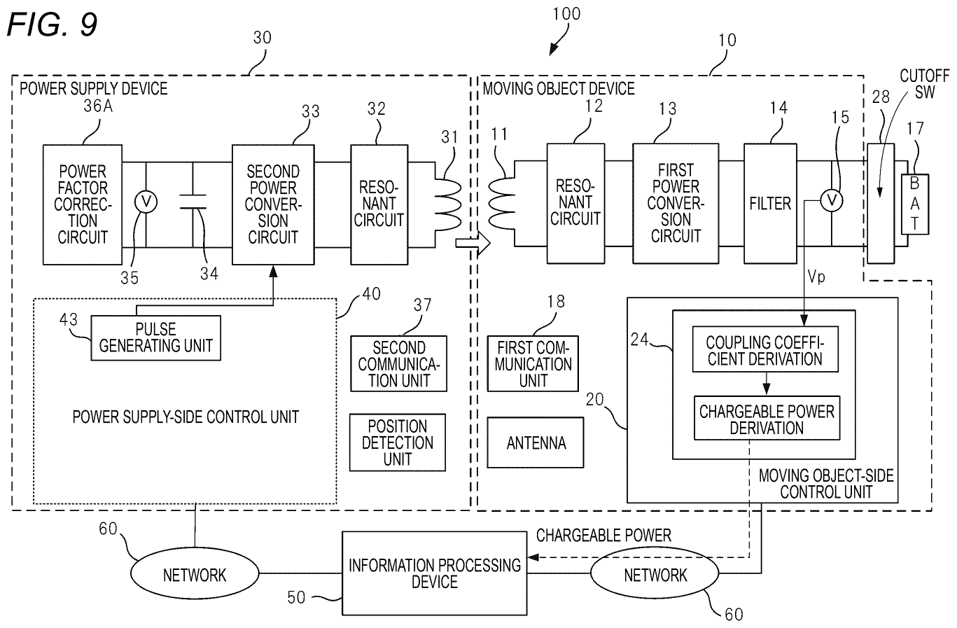

FIG. 9 is a schematic diagram illustrating a first example of the operation of the contactless power transmission system 100 when the information processing device 50 performs the power order processing on the supply-demand adjustment server 70.

When the user of the moving object 10A performs alignment between the moving object 10A and the power supply device 30, the moving object-side control unit 20 controls the cutoff switch 28 to the cutoff state. In addition, the power supply-side control unit 40 generates a drive pulse with a predetermined pattern (a pattern with a fixed pulse width and fixed frequency) by the pulse generating unit 45, and controls the second power conversion circuit 33 in accordance with the drive pulse, thereby controlling the supply power to the power supply-side coil 31 and the resonant circuit 32 to predetermined power (a constant value). When the control is started, constant power is transmitted from the power supply device 30 to the moving object device 10, and the power is converted to a direct current by the first power conversion circuit 13, and thus an output voltage Vp of the first power conversion circuit 13 detected by the voltage detection circuit 15 increases.

When the transmission of the constant power from the power supply device 30 is started, the processor 24 of the moving object-side control unit 20 acquires the output voltage Vp from the voltage detection circuit 15, and derives the coupling coefficient between the moving object-side coil 11 and the power supply-side coil 31 based on the output voltage Vp.

The processor 24 derives the chargeable power based on the derived coupling coefficient, and transmits information on the chargeable power to the information processing device 50.

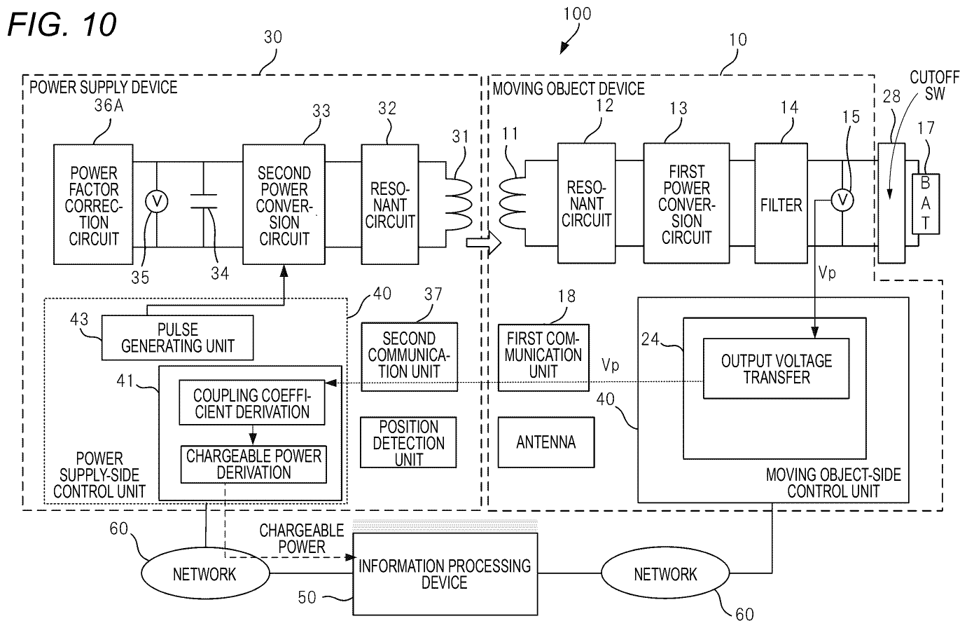

FIG. 10 is a schematic diagram illustrating a second example of the operation of the contactless power transmission system 100 when the information processing device 50 performs the power order processing on the supply-demand adjustment server 70.

In the example of FIG. 9, the processor 24 acquires the coupling coefficient and derives the chargeable power, but in the example of FIG. 10, the processor 41 of the power supply-side control unit 40 acquires the coupling coefficient and derives the chargeable power.

In the example of FIG. 10, when the constant power is transmitted from the power supply device 30 to the moving object device 10 in the same manner as the example of FIG. 9, the processor 24 of the moving object-side control unit 20 acquires the output voltage Vp from the voltage detection circuit 15 and stores data on a time-series transition of the output voltage Vp in the memory. When the data on the output voltage Vp necessary for deriving the coupling coefficient is accumulated, the processor 24 transmits the data to the power supply device 30.

When the processor 41 of the power supply-side control unit 40 acquires the data on the output voltage Vp transmitted from the moving object device 10, the processor 41 derives the coupling coefficient between the moving object-side coil 11 and the power supply-side coil 31 based on the data. The processor 41 derives the chargeable power based on the derived coupling coefficient, and transmits information on the chargeable power to the information processing device 50.

As described above, according to the operation examples illustrated in FIGS. 7 to 10, the coupling coefficient between the moving object-side coil 11 and the power supply-side coil 31 can be derived from the terminal voltage Vc of the capacitor 34 and the output voltage Vp of the first power conversion circuit 13 obtained by transmitting the constant power between the moving object device 10 and the power supply device 30, and the feedable power or the chargeable power can be derived based on the coupling coefficient.

As described above, by deriving the transmittable power using the coupling coefficient obtained by actually transmitting the power, it is possible to more accurately derive the feedable power or the chargeable power as compared with the operation examples illustrated in FIGS. 5 and 6. In addition, since it is not necessary to experimentally acquire the chargeable power or the feedable power, the construction cost of the system can be reduced.

In the present specification, at least the following matters are described. Although corresponding constituent elements or the like in the embodiment described above are shown in parentheses, the present invention is not limited thereto.
(1) An information processing system (information processing system 200) including an information processing device (information processing device 50) allowed to communicate with a plurality of contactless power transmission systems (contactless power transmission systems 100),
in which each of the contactless power transmission systems includes:
   a power supply device (power supply device 30) provided at a place where a moving object (moving object 10A) having a secondary battery (secondary battery 17) is allowed to be stopped; and
   a moving object device (moving object device 10) mounted on the moving object and configured to be allowed to perform contactless power transmission with the power supply device,
the secondary battery is allowed to be charged or discharged by performing the contactless power transmission between the power supply device and the moving object device,
the information processing device is provided to be allowed to communicate with at least one device of the moving object device or the power supply device included in the contactless power transmission system,
the one device (power supply device 30 or moving object device 10) is configured to:
   acquire a positional deviation amount (positional deviation amount MA) between a power supply-side coil (power supply-side coil 31) of the power supply device of the contactless power transmission system including the one device, and a moving object-side coil (moving object-side coil 11) of the moving object device of the contactless power transmission system including the one device;
   acquire a voltage (terminal voltage Vb) of the secondary battery of the moving object on which the moving object device of the contactless power transmission system including the one device is mounted;
   acquire transmittable power in a case where the contactless power transmission system including the one device performs the contactless power transmission, based on the acquired positional deviation amount and the acquired voltage, from a storage unit (memory 42 or memory 25) that stores information associating the positional deviation amount between the power supply-side coil and the moving object-side coil, the voltage of the secondary battery, and transmittable power (feedable power or chargeable power) in a case where the contactless power transmission is performed between the power supply device and the moving object device under a condition of the positional deviation amount and the voltage; and
   output information indicating the transmittable power to the information processing device, and
the information processing device derives, based on the information indicating the transmittable power output from the one device of each of the plurality of contactless power transmission systems, total power obtained by adding up respective transmittable powers, and performs processing based on the total power.
(2) An information processing system (information processing system 200) including an information processing device (information processing device 50) allowed to communicate with a plurality of contactless power transmission systems (contactless power transmission systems 100),
in which each of the contactless power transmission systems includes:
   a power supply device (power supply device 30) provided at a place where a moving object (moving object 10A) having a secondary battery (secondary battery 17) is allowed to be stopped; and
   a moving object device (moving object device 10) mounted on the moving object and configured to be allowed to perform contactless power transmission with the power supply device,
the secondary battery is allowed to be charged or discharged by performing the contactless power transmission between the power supply device and the moving object device,
the information processing device is provided to be allowed to communicate with at least one device of the moving object device or the power supply device included in the contactless power transmission system,
the one device (power supply device 30 or moving object device 10) is configured to:
   acquire a coupling coefficient between a power supply-side coil (power supply-side coil 31) of the power supply device of the contactless power transmission system including the one device, and a moving object-side coil (moving object-side coil 11) of the moving object device of the contactless power transmission system including the one device;
   derive transmittable power (feedable power or chargeable power) in a case where the contactless power transmission system performs the contactless power transmission, based on the coupling coefficient; and
   output information indicating the transmittable power to the information processing device, and
the information processing device derives, based on the information indicating the transmittable power output from the one device of each of the plurality of contactless power transmission systems, total power obtained by adding up respective transmittable powers, and performs processing based on the total power.
(3) The information processing system according to (1) or (2),
in which the information processing device derives the total power at a predetermined cycle, and performs bidding processing of power supply to a power system (power system 80) in a predetermined period after the total power is derived, based on the total power.
(4) A moving object device (moving object device 10) mounted on a moving object (moving object 10A) having a secondary battery (secondary battery 17) allowed to be charged or discharged by contactless power transmission, and configured to be allowed to perform the contactless power transmission with a power supply device (power supply device 30) provided at a place where the moving object is allowed to be stopped, the moving object device including:
a moving object-side coil (moving object-side coil 11); and
a control unit (moving object-side control unit 20),
in which the control unit is configured to:
   acquire a positional deviation amount (positional deviation amount MA) between a power supply-side coil (power supply-side coil 31) of the power supply device and the moving object-side coil;
   acquire a voltage (terminal voltage Vb) of the secondary battery;
   acquire transmittable power in a case where the contactless power transmission is performed with the power supply device, based on the acquired positional deviation amount and the acquired voltage, from a storage unit (memory 25) that stores information associating the positional deviation amount between the power supply-side coil and the moving object-side coil, the voltage of the secondary battery, and transmittable power (feedable power or chargeable power) in a case where the contactless power transmission is performed between the power supply device and the moving object device under a condition of the positional deviation amount and the voltage; and
   output information indicating the transmittable power to an outside.
(5) A moving object device (moving object device 10) mounted on a moving object (moving object 10A) having a secondary battery (secondary battery 17) allowed to be charged or discharged by contactless power transmission and configured to be allowed to perform the contactless power transmission with a power supply device (power supply device 30) provided at a place where the moving object is allowed to be stopped, the moving object device including:
a moving object-side coil (moving object-side coil 11); and
a control unit (moving object-side control unit 20),
in which the control unit is configured to:
   acquire a coupling coefficient between a power supply-side coil (power supply-side coil 31) of the power supply device and the moving object-side coil;
   derive transmittable power (feedable power or chargeable power) in a case where the contactless power transmission is performed with the power supply device, based on the coupling coefficient; and
   output information indicating the transmittable power to an outside.
(6) The moving object device according to (5),
in which the power supply device includes a capacitor (capacitor 34) to be charged with power transmitted by the contactless power transmission, and
the control unit performs control to transmit predetermined power from the moving object device to the power supply device, acquires a terminal voltage (terminal voltage Vc) of the capacitor charged with the predetermined power, and derives the coupling coefficient based on the terminal voltage to acquire the coupling coefficient.
(7) The moving object device according to (5), further including:
a power conversion circuit (first power conversion circuit 13) that converts power transmitted from the power supply device into power suitable for charging the secondary battery,
in which the control unit acquires an output voltage (output voltage Vp) of the power conversion circuit in a state that predetermined power is transmitted from the power supply device to the moving object device, and derives the coupling coefficient based on the output voltage to acquire the coupling coefficient.
(8) A power supply device (power supply device 30) configured to be allowed to perform contactless power transmission with a moving object device (moving object device 10) mounted on a moving object (moving object 10A) having a secondary battery (secondary battery 17) allowed to be charged or discharged by the contactless power transmission and provided at a place where the moving object is allowed to be stopped, the power supply device including:
a power supply-side coil (power supply-side coil 31); and
a control unit (power supply-side control unit 40),
in which the control unit is configured to:
   acquire a positional deviation amount (positional deviation amount MA) between the power supply-side coil and a moving object-side coil (moving object-side coil 11) of the moving object device;
   acquire a voltage (terminal voltage Vb) of the secondary battery;
   acquire transmittable power (feedable power or chargeable power) in a case where the contactless power transmission is performed with the moving object device, based on the acquired positional deviation amount and the acquired voltage, from a storage unit (memory 42) that stores information associating the positional deviation amount between the power supply-side coil and the moving object-side coil, the voltage of the secondary battery, and transmittable power in a case where the contactless power transmission is performed between the power supply device and the moving object device under a condition of the positional deviation amount and the voltage; and
   output information indicating the transmittable power to an outside.
(9) A power supply device (power supply device 30) configured to be allowed to perform contactless power transmission with a moving object device (moving object device 10) mounted on a moving object (moving object 10A) having a secondary battery (secondary battery 17) allowed to be charged or discharged by the contactless power transmission and provided at a place where the moving object is allowed to be stopped, the power supply device including:
a power supply-side coil (power supply-side coil 31); and
a control unit (power supply-side control unit 40),
in which the control unit is configured to:
   acquire a coupling coefficient between the power supply-side coil and a moving object-side coil (moving object-side coil 11) of the moving object device;
   derive transmittable power (feedable power or chargeable power) in a case where the contactless power transmission is performed with the moving object device, based on the coupling coefficient; and
   output information indicating the transmittable power to an outside.
(10) The power supply device according to (9),
in which the moving object device includes a power conversion circuit (first power conversion circuit 13) that converts power transmitted from the power supply device into power suitable for charging the secondary battery, and
the control unit is configured to:
   perform control to transmit predetermined power from the power supply device to the moving object device;
   acquire an output voltage (output voltage Vp) of the power conversion circuit in a state that the predetermined power is transmitted; and
   derive the coupling coefficient based on the output voltage to acquire the coupling coefficient.
(11) The power supply device according to (9), further including:
a capacitor (capacitor 34) allowed to be charged with power transmitted from the moving object device,
in which the control unit is configured to:
   acquire a terminal voltage (terminal voltage Vc) of the capacitor charged with predetermined power, in a state that the predetermined power is transmitted from the moving object device to the power supply device; and
   derive the coupling coefficient based on the terminal voltage to acquire the coupling coefficient.

What is claimed is:

1. An information processing system including an information processing device allowed to communicate with a plurality of contactless power transmission systems,
wherein each of the contactless power transmission systems includes:
a power supply device provided at a place where a moving object having a secondary battery is allowed to be stopped; and
a moving object device mounted on the moving object and configured to be allowed to perform contactless power transmission with the power supply device,
the secondary battery is allowed to be charged or discharged by performing the contactless power transmission between the power supply device and the moving object device,
the information processing device is provided to be allowed to communicate with at least one device of the moving object device or the power supply device included in the contactless power transmission system,
the one device is configured to:
acquire a positional deviation amount between a power supply-side coil of the power supply device of the contactless power transmission system including the one device, and a moving object-side coil of the moving object device of the contactless power transmission system including the one device;
acquire a voltage of the secondary battery of the moving object on which the moving object device of the contactless power transmission system including the one device is mounted;
acquire transmittable power in a case where the contactless power transmission system including the one device performs the contactless power transmission, based on the acquired positional deviation amount and the acquired voltage, from a storage unit that stores information associating the positional deviation amount between the power supply-side coil and the moving object-side coil, the voltage of the secondary battery, and transmittable power in a case where the contactless power transmission is performed between the power supply device and the moving object device under a condition of the positional deviation amount and the voltage; and
output information indicating the transmittable power to the information processing device, and
the information processing device derives, based on the information indicating the transmittable power output from the one device of each of the plurality of contactless power transmission systems, total power obtained by adding up respective transmittable powers, and performs processing based on the total power.

2. An information processing system including an information processing device allowed to communicate with a plurality of contactless power transmission systems,
wherein each of the contactless power transmission systems includes:
a power supply device provided at a place where a moving object having a secondary battery is allowed to be stopped; and
a moving object device mounted on the moving object and configured to be allowed to perform contactless power transmission with the power supply device,
the secondary battery is allowed to be charged or discharged by performing the contactless power transmission between the power supply device and the moving object device,
the information processing device is provided to be allowed to communicate with at least one device of the moving object device or the power supply device included in the contactless power transmission system,
the one device is configured to:
acquire a coupling coefficient between a power supply-side coil of the power supply device of the contactless power transmission system including the one device, and a moving object-side coil of the moving object device of the contactless power transmission system including the one device;
derive transmittable power in a case where the contactless power transmission system including the one device performs the contactless power transmission, based on the coupling coefficient; and
output information indicating the transmittable power to the information processing device, and
the information processing device derives, based on the information indicating the transmittable power output from the one device of each of the plurality of contactless power transmission systems, total power obtained by adding up respective transmittable powers, and performs processing based on the total power.

3. The information processing system according to claim 1,
wherein the information processing device derives the total power at a predetermined cycle, and performs bidding processing of power supply to a power system in a predetermined period after the total power is derived, based on the total power.

4. A moving object device mounted on a moving object having a secondary battery allowed to be charged or discharged by contactless power transmission, and configured to be allowed to perform the contactless power transmission with a power supply device provided at a place where the moving object is allowed to be stopped, the moving object device comprising:
a moving object-side coil; and
a control unit,
wherein the control unit is configured to:
acquire a positional deviation amount between a power supply-side coil of the power supply device and the moving object-side coil;
acquire a voltage of the secondary battery;
acquire transmittable power in a case where the contactless power transmission is performed with the power supply device, based on the acquired positional deviation amount and the acquired voltage, from a storage unit that stores information associating the positional deviation amount between the power supply-side coil and the moving object-side coil, the voltage of the secondary battery, and transmittable power in a case where the contactless power transmission is performed between the power supply device and the moving object device under a condition of the positional deviation amount and the voltage; and
output information indicating the transmittable power to an outside.

5. A moving object device mounted on a moving object having a secondary battery allowed to be charged or discharged by contactless power transmission, and configured to be allowed to perform the contactless power transmission with a power supply device provided at a place where the moving object is allowed to be stopped, the moving object device comprising:
a moving object-side coil; and
a control unit,
wherein the control unit is configured to:
acquire a coupling coefficient between a power supply-side coil of the power supply device and the moving object-side coil;
derive transmittable power in a case where the contactless power transmission is performed with the power supply device, based on the coupling coefficient; and
output information indicating the transmittable power to an outside.

6. The moving object device according to claim 5,
wherein the power supply device includes a capacitor to be charged with power transmitted by the contactless power transmission, and
the control unit performs control to transmit predetermined power from the moving object device to the power supply device, acquires a terminal voltage of the capacitor charged with the predetermined power, and derives the coupling coefficient based on the terminal voltage to acquire the coupling coefficient.

7. The moving object device according to claim 5, further comprising:
a power conversion circuit that converts power transmitted from the power supply device into power suitable for charging the secondary battery,
wherein the control unit acquires an output voltage of the power conversion circuit in a state that predetermined power is transmitted from the power supply device to the moving object device, and derives the coupling coefficient based on the output voltage to acquire the coupling coefficient.

8. A power supply device configured to be allowed to perform contactless power transmission with a moving object device mounted on a moving object having a secondary battery allowed to be charged or discharged by the contactless power transmission, and provided at a place where the moving object is allowed to be stopped, the power supply device comprising:
a power supply-side coil; and
a control unit,
wherein the control unit is configured to:
acquire a positional deviation amount between the power supply-side coil and a moving object-side coil of the moving object device;
acquire a voltage of the secondary battery;
acquire transmittable power in a case where the contactless power transmission is performed with the moving object device, based on the acquired positional deviation amount and the acquired voltage, from a storage unit that stores information associating the positional deviation amount between the power supply-side coil and the moving object-side coil, the voltage of the secondary battery, and transmittable power in a case where the contactless power transmission is performed between the power supply device and the moving object device under a condition of the positional deviation amount and the voltage; and
output information indicating the transmittable power to an outside.

9. A power supply device configured to be allowed to perform contactless power transmission with a moving object device mounted on a moving object having a secondary battery allowed to be charged or discharged by the contactless power transmission, and provided at a place where the moving object is allowed to be stopped, the power supply device comprising:
a power supply-side coil; and
a control unit,
wherein the control unit is configured to:
acquire a coupling coefficient between the power supply-side coil and a moving object-side coil of the moving object device;
derive transmittable power in a case where the contactless power transmission is performed with the moving object device, based on the coupling coefficient; and
output information indicating the transmittable power to an outside.

10. The power supply device according to claim 9,
wherein the moving object device includes a power conversion circuit that converts power transmitted from the power supply device into power suitable for charging the secondary battery, and
the control unit is configured to:
perform control to transmit predetermined power from the power supply device to the moving object device;
acquire an output voltage of the power conversion circuit, in a state that the predetermined power is transmitted; and
derive the coupling coefficient based on the output voltage to acquire the coupling coefficient.

11. The power supply device according to claim 9, further comprising:
a capacitor allowed to be charged with power transmitted from the moving object device,
wherein the control unit is configured to:
acquire a terminal voltage of the capacitor charged with predetermined power, in a state that the predetermined power is transmitted from the moving object device to the power supply device; and
derive the coupling coefficient based on the terminal voltage to acquire the coupling coefficient.

12. The information processing system according to claim 2,
wherein the information processing device derives the total power at a predetermined cycle, and performs bidding processing of power supply to a power system in a predetermined period after the total power is derived, based on the total power.
